(19) United States
(12) Patent Application Publication
(10) Pub. No.: US 2017/0048925 A1
(43) Pub. Date: Feb. 16, 2017

(54) APPARATUS AND METHOD FOR MANAGING NETWORK OF DRONE

(71) Applicant: SAMSUNG SDS CO., LTD., Seoul (KR)

(72) Inventors: Sung-Hak SONG, Seoul (KR); Kyu-ha CHOI, Seoul (KR); Jae-Sung KIM, Seoul (KR); Soon-Kyu PARK, Seoul (KR); Yun-Ho JO, Seoul (KR)

(73) Assignee: SAMSUNG SDS CO., LTD., Seoul (KR)

(21) Appl. No.: 14/995,846

(22) Filed: Jan. 14, 2016

(30) Foreign Application Priority Data
Aug. 13, 2015 (KR) 10-2015-0114348

(51) Int. Cl. H04W 84/20; H04W 40/22; H04W 72/08; H04W 24/08

(52) U.S. Cl. CPC H04W 84/20; H04W 24/08; H04W 40/22; H04W 72/085

(57) ABSTRACT

An apparatus and method of managing a network for a drone are disclosed. The apparatus for managing a network for a drone according to an exemplary embodiment of the present disclosure includes a receiver configured to receive first quality information of a base station signal from a drone, a measurer configured to measure second quality information of a base station signal received from the base station, and a determiner configured to determine whether the drone operates as a master drone for relaying the network between at least one child drone and the base station of a communication network based on the received first quality information and the measured second quality information.

### CROSS-REFERENCE TO RELATED APPLICATION

This application claims priority to and the benefit of Korean Patent Application No. 10-2015-0114348, filed on Aug. 13, 2015, the disclosure of which is incorporated herein by reference in its entirety.

### BACKGROUND

### 1. Field

Embodiments of the present disclosure relate to a technology for managing a network for a drone.

### 2. Discussion of Related Art

Drones are flying bodies that fly through remote control without a person boarding or fly autonomously along a designated path. Drones have been utilized mainly for military purpose. In recent years, drones have been utilized in various fields such as the transportation field or the security field, and for personal purpose.

With the widespread use of drones, consumption of a bandwidth of a network for remotely controlling the drones may increase and delay of the network may occur. When the network delay occurs, the drones are not appropriately controlled during flight. Accordingly, the drones may intrude a controlled area or collide with a building or other drones.

Accordingly, there is need for a technology capable of appropriately adjusting a drone by efficiently utilizing a network.

### SUMMARY

Embodiments of the present disclosure provide an apparatus and method of managing a network for a drone.

According to an exemplary embodiment of the present disclosure, there is provided an apparatus for managing a network for a drone, including: a receiver configured to receive first quality information of a base station signal from a drone; a measurer configured to measure second quality information of a base station signal received from the base station; and a determiner configured to determine whether the drone operates as a master drone for relaying the network between at least one child drone and the base station of a communication network based on the received first quality information and the measured second quality information.

At least one from among the quality information and the second quality information may include at least one of intensity and a signal-to-noise ratio (SNR) of the base station signal received by the master drone and the at least one child drone. The determiner may include the measured second quality information with the first quality information received from the drone, and determines that the drone operates as the master drone when the measured second quality information of the base station signal indicates at least one from among a higher intensity and higher signal-to-noise ratio.

The receiver may receive, from the drone, a number of child drones for which a network between the child drones and the base station is relayed by the drone, and the determiner determines that the drone operates as the master drone when the number of child drones for which a network between the child drones and the base station is relayed by the drone exceeds a preset number.

The apparatus for managing a network for a drone may further include: a controller configured to transmit a master drone change request message to the at least one child drone when it is determined that the drone operates as the master drone.

The master drone change request message may include the measured second quality information.

The controller may relay a network between at least one child drone transmitting a master drone change approval message and the base station in response to a reception of the master drone change approval message from the at least one child drone.

According to another exemplary embodiment of the present disclosure, there is provided an apparatus for managing a network for a drone, including: a receiver configured to receive first quality information of a base station signal received from a master drone for relaying a network between at least one child drone and a base station of a communication network, and a master drone change request message from the at least one child drone; and a determiner configured to determine whether the master drone is to be changed based on the quality information received from the master drone.

The quality information may include at least one from among intensity and a signal-to-noise ratio (SNR) of the base station signal received by the master drone and the at least one child drone.

The master drone change request message may include the second quality information of the base station signal received from the at least one child drone.

The determiner may compare the second quality information received from the at least one child drone with the first quality information received from the master drone in response to the reception of the master drone change request message from the at least one child drone, and changes one of the at least one child drone into a master drone when the second quality information of the base station signal received from the at least one child drone indicates at least one from among a higher intensity and higher signal-to-noise ratio.

The apparatus for managing a network for a drone may further include: a controller configured to block a connection to the master drone when it is determined that the master drone is to be changed, and transmit a master drone change approval message to the at least one child drone transmitting the master drone change request message.

According to still another exemplary embodiment of the present disclosure, there is provided a method of managing a network for a drone, including: receiving first quality information of a base station signal from a drone; measuring second quality information of a base station signal received from a base station; and determining whether the drone operates as a master drone for relaying a network between at least one child drone and the base station based on the received first quality information and the measured second quality information.

The quality information may include at least one from among intensity and a signal-to-noise ratio (SNR) of the base station signal received by the master drone and the at least one child drone.

The determining may include comparing the measured second quality information with the first quality information received from the drone, and determining that the drone operates as the master drone when the measured second quality information of the base station signal indicates at least one from among a higher intensity and higher signal-to-noise ratio.

The receiving may include receiving, from the drone, a number of child drones for which a network between the child drones and the base station is relayed by the drone, and the determining may include determining that the drone operates as the master drone when the number of child drones exceeds a preset number.

The method of managing a network for a drone may further include: transmitting a master drone change request message to the at least one child drone when it is determined that the drone operates as the master drone.

The master drone change request message may include the measured second quality information.

The method of managing a network for a drone may further include: relaying a network between the at least one child drone transmitting the master drone change approval message and the base station in response to a reception of the master drone change approval message from the at least one child drone.

According to still another exemplary embodiment of the present disclosure, there is provided a method of managing a network for a drone, including: receiving first quality information of a base station signal received from a master drone for relaying a network between at least one child drone and a base station of a communication network; receiving a master drone change request message from the at least one child drone; and determining whether the master drone is to be changed based on the first quality information received from the master drone.

The quality information may include at least one from among intensity and a signal-to-noise ratio (SNR) of the base station signal received by the master drone and the at least one child drone.

The master drone change request message may include the second quality information of the base station signal received from the at least one child drone.

The determining may include comparing the second quality information received from the at least one child drone with the first quality information received from the master drone when the master drone change request message is received from the at least one child drone; and determining that one of the at least one child drone is to be changed into a master drone when the second quality information of the base station signal received from the at least one child drone indicates at least one from among a higher intensity and higher signal-to-noise ratio.

The method of managing a network for a drone may further include: blocking a connection to the master drone when it is determined that the master drone is to be changed; and transmitting a master drone change approval message to the at least one child drone transmitting the master drone change request message.

According to still another exemplary embodiment of the present disclosure, there is provided a drone, including: a receiver configured to receive first quality information of a base station signal from a drone; a measurer configured to measure second quality information of a base station signal received from the base station; and a determiner configured to determine whether the drone operates as a master drone for relaying a network between at least one child drone and a base station based on the received first quality information and the measured second quality information.

According to still another exemplary embodiment of the present disclosure, there is provided a drone, including: a receiver configured to receive quality information of a base station signal received from a master drone for relaying a network between at least one child drone and a base station of a communication network, and a master drone change request message from the at least one child drone; and a determiner configured to determine whether the master drone is to be changed based on the quality information received from the master drone.

According to exemplary embodiments of the present disclosure, by setting at least one master drone and by the master drone relaying a network between a plurality of child drones and a base station, it is possible to reduce an amount of consumption of a bandwidth of a network and prevent a delay of signal transmission.

According to exemplary embodiments of the present disclosure, it is possible to achieve smooth exchange of data between the master drone and a plurality of child drone by selecting a drone in which intensity or a signal-to-noise ratio (SNR) of a signal received from the base station is highest, as the master drone.

According to exemplary embodiments of the present disclosure, it is possible to prevent transmission of a signal from being delayed due to generation of traffic of the network relayed by the master drone by limiting the number of child drones belonging to one group.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a block diagram illustrating a configuration of a system for managing a network for a drone according to an exemplary embodiment of the present disclosure

FIG. 2 is a block diagram illustrating a configuration of an apparatus for managing a network for a drone according to an exemplary embodiment of the present disclosure

FIG. 3 is a flowchart illustrating a method of managing a network for a drone according to a first exemplary embodiment of the present disclosure

FIG. 4 is a flowchart illustrating a method of managing a network for a drone according to a second exemplary embodiment of the present disclosure

FIG. 5 is a flowchart illustrating a method of managing a network for a drone according to a third exemplary embodiment of the present disclosure

### DETAILED DESCRIPTION OF EXEMPLARY EMBODIMENTS

Hereinafter, specific exemplary embodiments of the present disclosure will be described with reference to the drawings. The following detailed description is provided to assist in comprehensive understanding of methods, apparatuses, and/or systems described herein. However, this is merely illustrative, and the present disclosure is not limited thereto.

When a detailed description of known art related to the present disclosure is determined to unnecessarily obscure the subject matter of the present disclosure in describing exemplary embodiments of the present disclosure, the detailed description will be omitted. The terms to be described below are terms defined in consideration of functions in the present disclosure and may vary according to an intention of a user or an operator or practice. Therefore, definitions thereof will be determined based on content of the entire specification. The terms used in the detailed description are merely intended to describe the exemplary embodiments of the present disclosure and should not be limited in any way. The singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

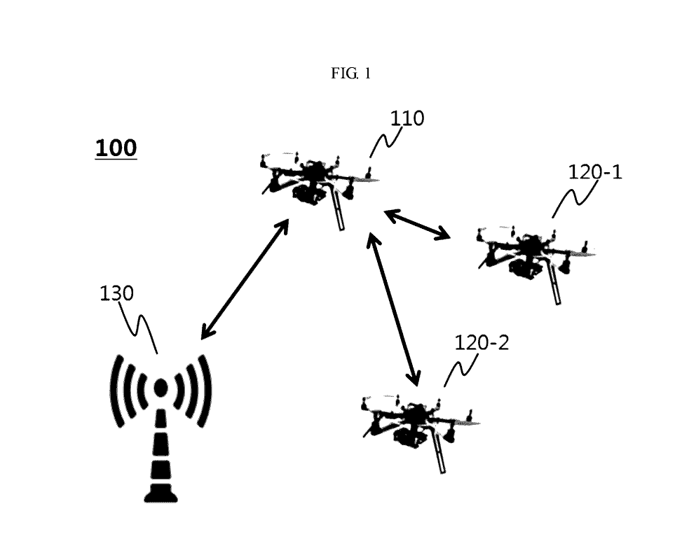

FIG. 1 is a block diagram illustrating a configuration of a system 100 for managing a network for a drone according to an exemplary embodiment of the present disclosure. As illustrated in FIG. 1, the system for managing the network for a drone includes a master drone 110, a child drone 120, and a base station 130.

The drone according to exemplary embodiments of the present disclosure is a flying body that flies through remote control without a person boarding or flies autonomously along a designated path. The drone may also be referred to as an unmanned aerial vehicle (UAV). The drone may include any type of flying body that can fly through remote control without a person boarding or fly autonomously along a designated path, and is not limited to a specific name and type.

The drone according to an exemplary embodiment of the present disclosure may be classified into the master drone 110 or the child drone 120 according to whether the drone relays a base station signal received directly from the base station 130 to at least another drone or whether the drone receives a relayed base station signal from another drone. Specifically, the master drone 110 may relay a network between the base station 130 and the child drone 120. Further, the child drone 120 may use the network between the child drone 120 and the base station 130 relayed by the master drone 110.

Meanwhile, the master drone 110 and the child drone 120 may be configured to have the same structure and the same function. For example, according to, for example, the quality of the base station signal, a drone operating as the master drone 110 may be changed into the child drone 120, and conversely the child drone 120 may be changed into the master drone 110. Hereinafter, the master drone 110 and the child drone 120 will be separately described in detail.

Meanwhile, when any one master drone 110 relays a network between at least one child drone 120 and the base station 130, the master drone 110 and the at least one child drone 120 may be considered to constitute one group.

The master drone 110 may relay the network between the at least one child drone 120 and the base station 130 of the wireless communication network. In an exemplary embodiment, the network may refer to transmitting or receiving the base station signal using the wireless communication network. That is, the master drone 110 may receive the base station signal from the base station 130 and transmit the received base station signal to the child drone 120.

The wireless communication system is a network that is operated by a wireless communication provider. For example, the wireless communication system may be a mobile communication network of a wideband code division multiple access (WCDMA) scheme or a long term evolution (LTE) scheme, but is not necessarily limited thereto and may include networks of various schemes that provide a wireless communication service to a wireless communication terminal using a plurality of base stations 130.

The base station signal may include, for example, a flight path and a flight altitude, flight restriction information, and a control signal for controlling an operation of the master drone 110 or the child drone 120. For example, when the master drone 110 or the child drone 120 autonomously flies, the master drone 110 or the child drone 120 may fly according to the flight path and the flight altitude received from the base station 130. In an exemplary embodiment of the present disclosure, the master drone 110 or the child drone 120 may receive the base station signal from the base station 130 over the wireless communication network to change the flight path and the flight altitude.

Meanwhile, the flight restriction information may include information on an area in which it is necessary to control the flight or functions of the master drone 110 or the child drone 120. For example, the flight restriction information may include information on at least one of a flight restricted area in which the flight of the master drone 110 or the child drone 120 is restricted or prohibited and a function restricted area in which it is necessary to restrict the function of the master drone 110 or the child drone 120.

In a specific example, the flight restricted area may include, for example, an area in which flight is legally prohibited, such as a military area, an area in which a flight altitude is restricted to be equal to or higher than a certain altitude or equal to or lower than the certain altitude, an area in which there is an obstacle with which the drone is likely to collide, such as a skyscraper, and an area in which flight should be authorized in advance. Further, the function restricted area may include, for example, an area in which photography is prohibited.

According to an exemplary embodiment of the present disclosure, by setting at least one drone as the master drone 110 and by the master drone 110 relaying a network between a plurality of child drones 120 and the base station 130, it is possible to reduce an amount of consumption of a bandwidth of the network and prevent delay of signal transmission. Specifically the base station 130 may transmit the base station signal to the at least one master drone 110 without needing to transmit the base station signal to the at least one master drone 110 and the plurality of child drones 120, and the master drone 110 may transit the received base station signal to the plurality of child drones 120.

Meanwhile, according to an exemplary embodiment of the present disclosure, the master drone 110 and at least one of the child drones 120 can perform wireless communication with the base station 130, and the master drone 110 and the plurality of child drones 120 can also perform wireless communication with each other.

The master drone may measure quality information of the base station signal received from the base station. According to an exemplary embodiment of the present disclosure, the quality information of the base station signal may include at least one of intensity and a signal-to-noise ratio (SNR) of the base station signal received by the master drone 110. Specifically the quality information of the base station signal may be the intensity or the signal-to-noise ratio of the base station signal which is selectable according to a setting of a manager, but is not necessarily limited thereto and may include both of the intensity and the signal-to-noise ratio of the base station signal, which may be weighted for measurement of the quality information of the base station signal.

For example, the master drone 110 may measure the intensity (for example, 10 dBm) of the base station signal received from the base station 130. In an example, the master drone 110 may measure a signal-to-noise ratio (for example, 3 dB) of the base station signal received from the base station 130. In another example, the master drone 110 and the at least one child drone 120 may weight the intensity and the signal-to-noise ratio of the base station signal in a ratio of 7:3 to measure quality information of the base station signal.

The master drone 110 may acquire information on the number of child drones 120 for which the network between the child drones and the base station is relayed by the master drone 110, that is, the number of child drones 120 in a group to which the master drone 110 belongs. For example, the child drone 120 may request the master drone 110 to transmit the base station signal, and the master drone 110 may acquire the number (for example, five) of child drones 120 in the group to which the master drone 110 belongs, based on the number of requests for transmission of the base station signal, but a method of acquiring the number of child drones in the group is not particularly limited.

Meanwhile, the master drone 110 may measure quality information of the base station signal and the number of child drones 120 in a group in every set period, and transmit the measured quality information and the measured number of child drones 120 to at least one child drone 120.

The child drone 120 uses a network between the child drone 120 and the base station 130 relayed by the master drone 110. Accordingly, the child drone 120 may receive the base station signal from the master drone 110.

The child drone 120 may receive the quality information (first quality information) of the base station signal from the master drone 110. Specifically, the master drone 110 may measure the quality information of the base station signal received from the base station 130, and transmit the measured quality information to the child drone 120. The quality information of the base station signal may include at least one of the intensity and the signal-to-noise ratio of the base station signal, as described above.

The child drone 120 may measure the quality information (second quality information) of the base station signal received from the base station 130. According to an exemplary embodiment, while the child drone 120 receives the base station signal from the master drone 110, the child drone 120 may directly receive the base station signal from the base station and measure the quality information of the received base station signal.

The child drone 120 may determine whether the child drone operates as a master drone based on the measured quality information of the base station signal and the quality information of the base station signal received from the master drone 110.

According to a first exemplary embodiment of the present disclosure, when the measured quality information of the base station signal is better than the quality information of the base station signal received from the master drone 110, the child drone 120 may determine that the child drone 120 operates as a master drone. Better quality of a signal means a higher intensity and/or a greater signal-to-noise ratio of the signal. That is, when the intensity and/or the signal-to-noise ratio of the base station signal that the child drone 120 receives from the base station is greater than the intensity and/or the signal-to-noise ratio of the base station signal received by the master drone 110, it may be determined that the child drone operates as a master drone.

When the child drone 120 is determined to operate as the master drone, the child drone 120 may transmit a master drone change request message to at least one child drone 120. According to an exemplary embodiment of the present disclosure, the master drone change request message may include the quality information of the base station signal measured by the child drone and identification information of the child drone. The identification information may be, for example, a unique number assigned to each child drone, but is not limited thereto.

According to an exemplary embodiment of the present disclosure, the child drone 120 may receive a master drone change approval message from the at least one child drone to which the master drone change request message is transmitted. In this case, the child drone 120 may operate as the master drone for the child drone transmitting the master drone change approval message, and relay the network between the child drone and the base station.

According to exemplary embodiments of the present disclosure, it is possible to reduce delay of data transmission by selecting the child drone 120 in which quality information of the base station signal received from the base station is best, as the master drone 110.

According to a second exemplary embodiment of the present disclosure, the child drone 120 may receive the number of child drones 120 for which the network between the child drones 120 and the base station is relayed from the master drone 110. Further, since the number of child drones 120 for which the network between the child drones 120 and the base station is relayed, which is received from the master drone 110, may increase due to entrance of a new drone, the child drone 120 may receive the number of child drones in a group to which the child drone 120 belongs, from the master drone 110 in every preset period.

When the number of child drones in the group to which the child drone 120 belongs exceeds a preset number, the child drone 120 may determine that the child drone 120 operates as an additional master drone. For example, when the number of drones in any one group exceeds seven, the child drone 120 may determine that the child drone 120 operates the additional master drone.

According to exemplary embodiments of the present disclosure, it is possible to prevent transmission of a signal from being delayed due to an increase in traffic of the network relayed by the master drone 110 by limiting the number of child drones 120 belonging to one group.

If the child drone 120 is determined to operate as an additional master drone, the master drone change request message may be transmitted to at least one child drone.

According to an exemplary embodiment of the present disclosure, the child drone 120 may receive a master drone change approval message from the at least one child drone to which the master drone change request message is transmitted. In this case, the child drone 120 may relay a network between the at least one child drone and the base station 130.

According to a third exemplary embodiment of the present disclosure, the child drone 120 may receive a master drone change request message from at least one child drone. In this case, the master drone change request message may include quality information of the base station signal that the at least one child drone 120 receives from the base station.

The child drone 120 receiving the master drone change request message may measure the quality information of the base station signal received from the master drone 110. The child drone 120 may compare the measured quality information of the base station signal with the received quality information of the base station signal.

When the quality information of the base station signal received from at least one child drone 120 is better than the measured quality information of the base station signal, the child drone 120 may determine that the master drone is changed. Further, the child drone 120 may transmit a master drone change approval message to the child drone 120 transmitting the master drone change request message. In this case, the master drone change approval message may include a message for request for relay of the network between the child drone and the base station. Further, the child drone may block the connection with the existing master drone.

Meanwhile, while one master drone 110, one base station 130, and two child drones 120-1 and 120-2 have been illustrated in in FIG. 1, this is intended for convenience of description, and the number of the master drone 110, the child drone 120, and the base station 130 is not limited in the exemplary embodiments of the present disclosure.

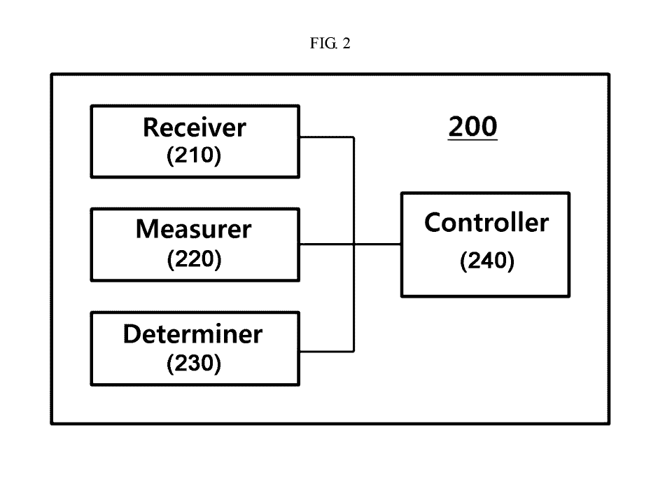

FIG. 2 is a block diagram illustrating a configuration of an apparatus 200 for managing a network for a drone according to an exemplary embodiment of the present disclosure. As illustrated in FIG. 2, the apparatus 200 for managing a network for a drone according to an exemplary embodiment of the present disclosure may include a receiver 210, a measurer 220, a determiner 230, and a controller 240. The apparatus 200 for managing a network for a drone according to an exemplary embodiment of the present disclosure may be implemented as one configuration included in the master drone and the child drone.

The receiver 210 may receive the base station signal from the master drone 110. Further, the receiver 210 may receive the measured quality information of the base station signal from the master drone 110 and the other child drones 120. According to an exemplary embodiment of the present disclosure, the quality information of the base station signal may include at least one of signal intensity and a signal-to-noise ratio.

Further, the receiver 210 may receive the number of the child drones 120 present in a group to which the master drone belongs, from the master drone 110.

Further, the receiver 210 may receive identification information from each of the master drone 110 and the other child drones 120.

Meanwhile, the receiver 210 may directly receive the base station signal from the base station 130.

The measurer 220 may measure the quality information of the base station signal received directly from the base station 130. Therefore, the measurer 220 may measure the intensity and/or the signal-to-noise ratio of the base station signal received from the base station 130.

The determiner 230 may determine whether or not the child drone operates as a master drone.

According to a first exemplary embodiment of the present disclosure, when the measured quality information of the base station signal is better than the quality information of the base station signal received from the master drone 110, the determiner 230 may determine that the child drone operates as a master drone.

According to a second exemplary embodiment of the present disclosure, when the number of child drones 120 in the group that the own drone belongs exceeds a preset number, the determiner 230 may determine that the child drone operates as a master drone.

The determiner 230 may compare the measured quality information of the base station signal received from the master drone 110 with the quality information of the base station signal received from at least one of the child drones in response to the reception of the master drone change request message from the at least one child drone. According to an exemplary embodiment, the master drone change request message may include the quality information of the base station signal measured by the at least one child drone.

When the received quality information of the base station signal is better than the measured quality information of the base station signal, the determiner 230 may determine that the master drone is to be changed. That is, the determiner 230 may determine that the child drone 120 transmitting the master drone request message operates as a master drone 110.

When it is determined that the child drone 120 operates as a master drone 110, the controller 240 may transmit a master drone change request message to at least one child drone.

When it is determined that a specific child drone operates as a master drone, the controller 240 may transmit a master drone change approval message to the child drone 120. In this case, the controller 240 may block a connection to an existing master drone 110. Meanwhile, the master drone change approval message may include a message for request for network relay between the child drone 120 and the base station 130.

In an exemplary embodiment, the receiver 210, the measurer 220, the determiner 230, and the controller 240 may be implemented on a computing device including one or more processors, and a computer-readable recording medium connected to the processor. The computer-readable recording medium may be arranged inside or outside the processor and connected to the processor by a variety of well-known means. The processor in the computing device can enable the computing device to operate according to the exemplary embodiments described herein. For example, the processor can execute instructions stored in the computer-readable recording medium, and when the instructions stored in the computer-readable recording medium are executed by the processor, the instructions enable the computing device to perform operations according to the exemplary embodiments described herein.

The apparatus 200 including the receiver 210, the measurer 220, the determiner 230, and the controller 240 can be implemented in the form of hardware, software, or the combination of both.

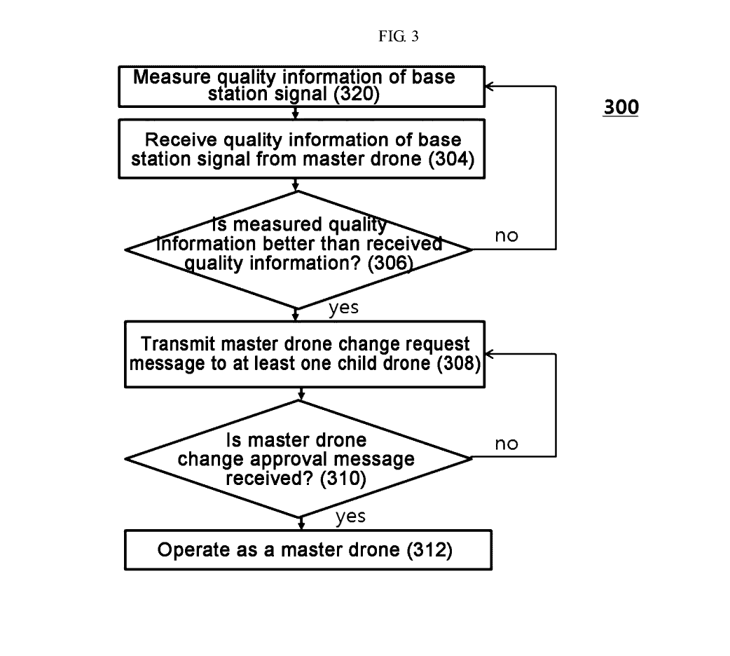

FIG. 3 is a flowchart illustrating a method 300 of managing a network for a drone according to the first exemplary embodiment of the present disclosure. The method illustrated in FIG. 3 may be performed by, for example, the apparatus 200 for managing a network for a drone described above. While the above-described method has been described as a plurality of divided operations in the illustrated flowchart, at least some of the operations may be performed in a changed order, performed in combination with other operations, omitted, performed as sub-operations, or performed with one or more additional operations that are not shown.

In operation 302, the apparatus 200 for managing a network for a drone may measure the quality information of the base station signal received from the base station. As described above, the quality information of the base station signal may include at least one of the signal intensity and the signal-to-noise ratio.

In operation 304, the apparatus 200 for managing a network for a drone may receive the quality information of the base station signal from the master drone 110. Specifically, the master drone 110 may directly measure the quality information of the base station signal received from the base station and transmit the measured quality information of the base station signal to the apparatus 200 for managing a network for a drone.

In operation 306, the apparatus 200 for managing a network for a drone may compare the measured quality information of the base station signal with the received quality information of the base station signal. In this case, when the measured quality information of the base station signal is better than the received quality information of the base station signal, the apparatus 200 for managing a network for a drone may determine that the child drone operates as a master drone. In this case, the better quality information of the base station signal means a higher intensity and/or a greater signal-to-noise ratio of the base station signal.

In operation 308, when it is determined that the child drone operates as a master drone, the apparatus 200 for managing a network for a drone may transmit a master drone change request message to at least one child drone 120. In this case, the master drone change request message may include the measured quality information of the base station signal.

In operation 310, the apparatus 200 for managing a network for a drone may receive a master drone change approval message as a response to the master drone change request message. In this case, the master drone change approval message may include a message for request for relay of the network between the child drone and the base station.

In operation 312, the apparatus 200 for managing a network for a drone may relay the network between the child drone transmitting the master drone change approval message and the base station in response to the reception of the master drone change approval message.

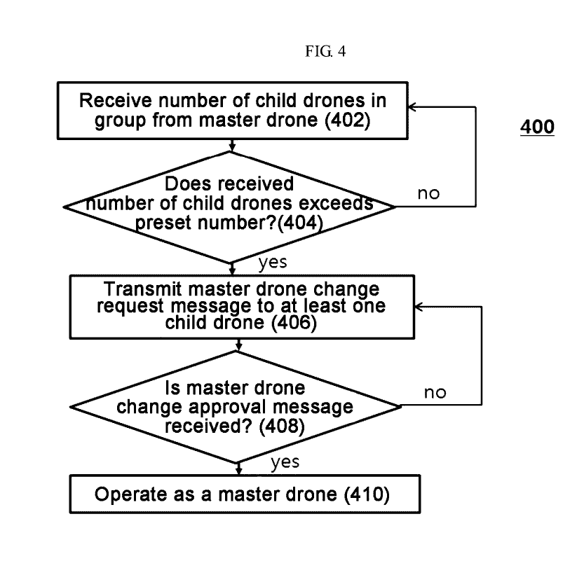

FIG. 4 is a flowchart illustrating a method 400 of managing a network for a drone according to the second exemplary embodiment of the present disclosure. The method illustrated in FIG. 4 may be performed by, for example, the apparatus 200 for managing a network for a drone described above. While the above-described method has been described as a plurality of divided operations in the illustrated flowchart, at least some of the operations may be performed in a changed order, performed in combination with other operations, omitted, performed as sub-operations, or performed with one or more additional operations that are not shown.

In operation 402, the apparatus 200 for managing a network for a drone may receive the number of child drones 120 for which the network between the child drones and the base station is relayed by the master drone 110, that is, the number of child drones 120 in a group to which the master drone 110 belongs.

In operation 404, when the number of child drones received from the master drone 110 120 exceeds a preset number, the apparatus 200 for managing a network for a drone determines that the drone operates as a master drone 110.

In operation 406, when it is determined that the drone operates as a master drone 110, the apparatus 200 for managing a network for a drone may transmit a master drone change request message to at least one child drone 120. In this case, the master drone change request message may include the measured quality information of the base station signal.

In operation 408, the apparatus 200 for managing a network for a drone may receive a master drone change approval message as a response to the master drone change request message. In this case, the master drone change approval message may include a message for request for relay of the network between the child drone 120 and the base station.

In operation 410, the apparatus 200 for managing a network for a drone may relay the network between the child drone transmitting the master drone change approval message and the base station in response to the reception of the master drone change approval message.

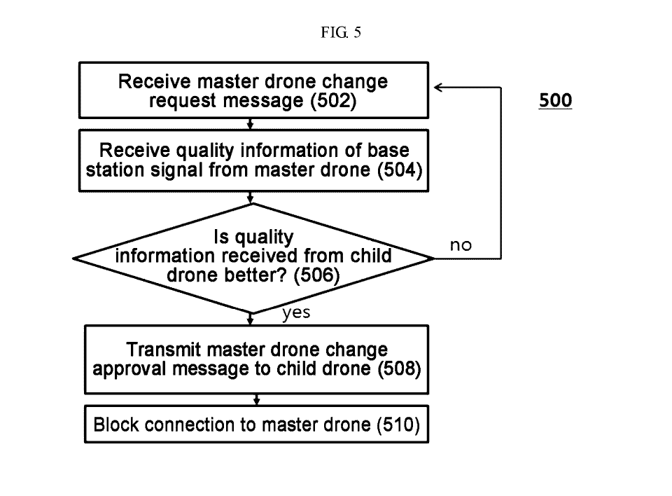

FIG. 5 is a flowchart illustrating a method 500 of managing a network for a drone according to the third exemplary embodiment of the present disclosure. The method illustrated in FIG. 5 may be performed by, for example, the apparatus 200 for managing a network for a drone described above. While the above-described method has been described as a plurality of divided operations in the illustrated flowchart, at least some of the operations may be performed in a changed order, performed in combination with other operations, omitted, performed as sub-operations, or performed with one or more additional operations that are not shown.

In operation 502, the apparatus 200 for managing a network for a drone may receive a master drone change request message from at least one child drone 120. In this case, the master drone change request message may include quality information of the base station signal measured by the at least one drone 120. Further, the quality information of the base station signal may include the intensity and/or the signal-to-noise ratio of the signal.

In operation 504, the apparatus 200 for managing a network for a drone may receive the quality information of the base station signal from the master drone 110. Specifically, the master drone 110 may measure the quality information of the base station signal received directly from the base station and transmit the measured quality information of the base station signal to the apparatus 200 for managing a network for a drone.

In operation 506, the apparatus 200 for managing a network for a drone may compare the quality information of the base station signal received from the at least one child drone 120 with the quality information of the base station signal received from the master drone 110. In this case, when the quality information of the base station signal received from the child drone 120 is better than the quality information of the base station signal received from the master drone 110 it may be determined that the child drone 120 operates as a master drone. In this case, the better quality information of the base station signal means a higher intensity and/or a greater signal-to-noise ratio of the base station signal.

In operation 508, when the child drone transmitting the master drone change request message is determined to operate as the master drone, the apparatus 200 for managing a network for a drone may transmit a master drone change approval message to the child drone 120. In this case, the master drone change approval message may include a message for a request for relay of the network between the child drone and the base station.

In operation 510, the apparatus 200 for managing a network for a drone may block connection to the existing master drone 110.

While the representative exemplary embodiments of the present disclosure have been described in detail, a person skilled in the art to which the present disclosure pertains will understand that several variations can be made to the exemplary embodiments without departing from the scope of the present disclosure. Therefore, the scope of the present disclosure should not be limited to the described exemplary embodiments, and should be determined by the claims to be described below and their equivalents.

What is claimed is:

1. An apparatus for managing a network for a drone, the apparatus comprising:
A receiver configured to receive first quality information of a base station signal from a drone;
a measurer configured to measure second quality information of a base station signal received from the base station; and
a determiner configured to determine whether the drone operates as a master drone for relaying the network between at least one child drone and the base station of a communication network based on the received first quality information and the measured second quality information.

2. The apparatus according to claim 1,
wherein at least one from among the first quality information and the second quality information includes at least one of intensity and a signal-to-noise ratio (SNR) of the base station signal received by the master drone and the at least one child drone.

3. The apparatus according to claim 1,
wherein the determiner compares the measured second quality information with the first quality information received from the drone, and determines that the drone operates as the master drone when the measured second quality information of the base station signal indicates at least one from among a higher intensity and higher signal-to-noise ratio.

4. The apparatus according to claim 1,
wherein the receiver receives, from the drone, a number of child drones for which a network between the child drones and the base station is relayed by the drone, and
the determiner determines that the drone operates as the master drone when the number of child drones for which a network between the child drones and the base station is relayed by the drone exceeds a preset number.

5. The apparatus according to claim 1, further comprising:
a controller configured to transmit a master drone change request message to the at least one child drone when it is determined that the drone operates as the master drone.

6. The apparatus according to claim 5,
wherein the master drone change request message includes the measured second quality information.

7. The apparatus according to claim 5,
wherein the controller relays a network between at least one child drone transmitting a master drone change approval message and the base station in response to a reception of the master drone change approval message from the at least one child drone.

8. An apparatus for managing a network for a drone, comprising:
a receiver configured to receive first quality information of a base station signal received from a master drone for relaying a network between at least one child drone and a base station of a communication network, and a master drone change request message from the at least one child drone; and
a determiner configured to determine whether the master drone is to be changed based on the quality information received from the master drone.

9. The apparatus according to claim 8,
wherein the quality information includes at least one from among intensity and a signal-to-noise ratio (SNR) of the base station signal received by the master drone and the at least one child drone.

10. The apparatus according to claim 8,wherein the master drone change request message includes second quality information of the base station signal received from the at least one child drone.

11. The apparatus according to claim 8,
wherein the determiner compares the second quality information received from the at least one child drone with the first quality information received from the master drone in response to the reception of the master drone change request message from the at least one child drone, and changes one of the at least one child drone into a master drone when the second quality information of the base station signal received from the at least one child drone indicates at least one from among a higher intensity and higher signal-to-noise ratio.

12. The apparatus according to claim 11, further comprising:
a controller configured to block a connection to the master drone when it is determined that the master drone is to be changed, and transmit a master drone change approval message to the at least one child drone transmitting the master drone change request message.

13. A method of managing a network for a drone, the method comprising:
receiving first quality information of a base station signal from a drone;
measuring second quality information of a base station signal received from a base station; and
determining whether the drone operates as a master drone for relaying a network between at least one child drone and the base station based on the received first quality information and the measured second quality information.

14. The method of managing a network for a drone according to claim 13,
wherein the quality information includes at least one from among intensity and a signal-to-noise ratio (SNR) of the base station signal received by the master drone and the at least one child drone.

15. The method of managing a network for a drone according to claim 13,
wherein the determining includes comparing the measured second quality information with the first quality information received from the drone, and determining that the drone operates as the master drone when the measured second quality information of the base station signal indicates at least one from among a higher intensity and higher signal-to-noise ratio.

16. The method of managing a network for a drone according to claim 13,
wherein the receiving includes receiving, from the drone, a number of child drones for which a network between the child drones and the base station is relayed by the drone, and
the determining includes determining that the drone operates as the master drone when the number of child drones exceeds a preset number.

17. The method of managing a network for a drone according to claim 13, further comprising:
transmitting a master drone change request message to the at least one child drone when it is determined that the drone operates as the master drone.

18. The method of managing a network for a drone according to claim 17,
wherein the master drone change request message includes the second measured quality information.

19. The method of managing a network for a drone according to claim 17, further comprising:
relaying a network between the at least one child drone transmitting the master drone change approval message and the base station in response to a reception of the master drone change approval message from the at least one child drone.

20. A method of managing a network for a drone, the method comprising:
receiving first quality information of a base station signal received from a master drone for relaying a network between at least one child drone and a base station of a communication network;
receiving a master drone change request message from the at least one child drone, and
determining whether the master drone is to be changed based on the first quality information received from the master drone.

21. The method of managing a network for a drone according to claim 20,
wherein the quality information includes at least one from among intensity and a signal-to-noise ratio (SNR) of the base station signal received by the master drone and the at least one child drone.

22. The method of managing a network for a drone according to claim 20,
wherein the master drone change request message includes second quality information of the base station signal received from the at least one child drone.

23. The method of managing a network for a drone according to claim 20,
wherein the determining includes:
comparing the second quality information received from the at least one child drone with the first quality information received from the master drone when the master drone change request message is received from the at least one child drone; and
determining that one of the at least one child drone is to be changed into a master drone when the second quality information of the base station signal received from the at least one child drone indicates at least one from among a higher intensity and higher signal-to-noise ratio.

24. The method of managing a network for a drone according to claim 23, further comprising:
blocking a connection to the master drone when it is determined that the master drone is to be changed; and transmitting a master drone change approval message to the at least one child drone transmitting the master drone change request message.

25. A drone, comprising:
a receiver configured to receive first quality information of a base station signal from a drone;
a measurer configured to measure second quality information of a base station signal received from the base station; and
a determiner configured to determine whether the drone operates as a master drone for relaying a network between at least one child drone and a base station based on the received first quality information and the measured second quality information.

26. A drone, comprising:
a receiver configured to receive quality information of a base station signal received from a master drone for relaying a network between at least one child drone and a base station of a communication network, and a master drone change request message from the at least one child drone; and
a determiner configured to determine whether the master drone is to be changed based on the quality information received from the master drone.
